(19) United States
(12) Patent Application Publication
(10) Pub. No.: US 2026/0332364 A1
(43) Pub. Date: Oct. 22, 2026

(54) CONTROL FORMAT INDICATOR (CFI) CONFIGURATIONS ASSOCIATED WITH ONE OR MORE CFI FORMATS

(71) Applicant: QUALCOMM Incorporated, San Diego, CA (US)

(72) Inventors: Weimin DUAN, San Diego, CA (US); Jing JIANG, San Diego, CA (US); Gabi SARKIS, San Diego, CA (US)

(21) Appl. No.: 19/649,564

(22) Filed: Apr. 16, 2026

Related U.S. Application Data
(60) Provisional application No. 63/791,155, filed on Apr. 18, 2025.

(51) Int. Cl. H04L 5/00; H04W 52/02

(52) U.S. Cl. CPC H04L 5/0094; H04L 5/0053; H04W 52/0235

(57) ABSTRACT

Various aspects of the present disclosure generally relate to wireless communication. In some aspects, a user equipment (UE) may receive a control format indicator (CFI) configuration that configures one or more CFI formats. The UE may receive a CFI based at least in part on the CFI configuration, wherein a wakeup of the UE and a downlink channel monitoring are based at least in part on a receipt of the CFI. Numerous other aspects are described.

### CROSS-REFERENCE TO RELATED APPLICATION

This Patent Application claims priority to U.S. Provisional Patent Application No. 63/791,155, filed on Apr. 18, 2025, entitled “CONTROL FORMAT INDICATOR (CFI) CONFIGURATIONS ASSOCIATED WITH ONE OR MORE CFI FORMATS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with control format indicator (CFI) configurations associated with one or more CFI formats.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

In some implementations, an apparatus for wireless communication at a user equipment (UE) includes one or more memories; and one or more processors, coupled to the one or more memories, which are configured, individually or in any combination, to: receive a control format indicator (CFI) configuration that configures one or more CFI formats; and receive a CFI based at least in part on the CFI configuration, wherein a wakeup of the UE and a downlink channel monitoring are based at least in part on a receipt of the CFI.

In some implementations, an apparatus for wireless communication at a network node includes one or more memories; and one or more processors, coupled to the one or more memories, which are configured, individually or in any combination, to: transmit a CFI configuration that configures one or more CFI formats; and transmit a CFI based at least in part on the CFI configuration, wherein a wakeup of a UE and a downlink channel monitoring are based at least in part on the CFI.

In some implementations, a method of wireless communication performed by a UE includes receiving a CFI configuration that configures one or more CFI formats; and receiving a CFI based at least in part on the CFI configuration, wherein a wakeup of the UE and a downlink channel monitoring are based at least in part on a receipt of the CFI.

In some implementations, a method of wireless communication performed by a network node includes transmitting a CFI configuration that configures one or more CFI formats; and transmitting a CFI based at least in part on the CFI configuration, wherein a wakeup of a UE and a downlink channel monitoring are based at least in part on the CFI.

In some implementations, a non-transitory computer-readable medium storing a set of instructions for wireless communication includes one or more instructions that, when executed by one or more processors of a UE, cause the UE to: receive a CFI configuration that configures one or more CFI formats; and receive a CFI based at least in part on the CFI configuration, wherein a wakeup of the UE and a downlink channel monitoring are based at least in part on a receipt of the CFI.

In some implementations, a non-transitory computer-readable medium storing a set of instructions for wireless communication includes one or more instructions that, when executed by one or more processors of a network node, cause the network node to: transmit a CFI configuration that configures one or more CFI formats; and transmit a CFI based at least in part on the CFI configuration, wherein a wakeup of a UE and a downlink channel monitoring are based at least in part on the CFI.

In some implementations, an apparatus for wireless communication includes means for receiving a CFI configuration that configures one or more CFI formats; and means for receiving a CFI based at least in part on the CFI configuration, wherein a wakeup of the apparatus and a downlink channel monitoring are based at least in part on a receipt of the CFI.

In some implementations, an apparatus for wireless communication includes means for transmitting a CFI configuration that configures one or more CFI formats; and means for transmitting a CFI based at least in part on the CFI configuration, wherein a wakeup of a UE and a downlink channel monitoring are based at least in part on the CFI.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless network.

FIGS. 2-4 are diagrams illustrating examples associated with control format indicator (CFI) configurations associated with one or more CFI formats.

FIG. 5 is a flowchart illustrating an example process performed, for example, by a user equipment (UE).

FIG. 6 is a flowchart illustrating an example process performed, for example, by a network node.

FIGS. 7-8 are diagrams of example apparatuses for wireless communication.

### DETAILED DESCRIPTION

In a wireless communication system, such as a Long Term Evolution (LTE) system, a control format indicator (CFI) may enable a control resource adaptation in a time domain. The CFI may be an indicator that is transmitted by a network node to a user equipment (UE). The CFI may indicate a number of orthogonal frequency division multiplexing (OFDM) symbols that are used for carrying a control channel, such as a physical downlink control channel (PDCCH) and a physical hybrid automatic repeat request (ARQ) indicator channel (PHICH), at each subframe. When the CFI is set to “1” for a subframe, one OFDM symbol (e.g., the first OFDM symbol) of the subframe may be used for a PDCCH allocation. When the CFI is set to “2”, two OFDM symbols (e.g., the first OFDM symbol and the second OFDM symbol) of the subframe may be used for the PDCCH allocation.

The CFI may indicate the number of OFDM symbols in the subframe that are used for control information on the downlink. The CFI may indicate one OFDM symbol, two OFDM symbols, or three OFDM symbols. In other words, the CFI may indicate whether a control region spans the first one OFDM symbol, two OFDM symbols, or three OFDM symbols. The CFI may be transmitted on a physical CFI channel (PCFICH), which may appear in the first OFDM symbol of each subframe. The CFI may indicate to the UE the number of OFDM symbols to read in order to obtain the control information before decoding data. Remaining OFDM symbols in the subframe may be used for a physical downlink shared channel (PDSCH), which may be used to convey data.

The CFI may be associated with various limitations. The CFI may restrict a dynamic resource multiplexing across data channels and control resources. For example, in a New Radio (NR) system, a PCFICH based PDCCH time domain resource indication may be removed due to the restriction of the dynamic resource multiplexing across data channels and control resources. The CFI may confine the PDCCH. A reliability of the CFI may be critical. When the CFI is decoded incorrectly, the PDCCH may not be properly decoded (e.g., PDCCH missing may be inevitable).

The CFI may indicate one, two, or three OFDM symbols per subframe, where such a fixed and narrow range may be insufficient in high traffic or high user density scenarios. A static nature of the CFI may result in wasted resources when an excessive number of OFDM symbols are allocated for the control information. Since the CFI is transmitted in the first OFDM symbol, any interference or corruption may cause the UE to misinterpret a control region size, miss PDCCH information altogether, or fail to decode scheduled data. The CFI may not be dynamic or flexible to dynamically changing traffic demands or new use cases. The CFI may not be suitable for beamforming or advanced antenna techniques. For example, the CFI may not support a flexible control region placement or beamformed control channels.

Downlink control information (DCI) that may be transmitted over the PDCCH. DCI may indicate instructions that allows the UE to decode data received over the PDSCH or transmit data over a physical uplink shared channel (PUSCH). DCI may indicate a resource allocation, a modulation and coding scheme (MCS), hybrid automatic repeat request (HARQ) process information, a new data indicator (NDI), a redundancy version (RV), power control commands, a timing advance (TA) command, an uplink grant, and/or a downlink assignment. The network node may transmit DCI on the PDCCH, which may be associated with the control region (e.g., a first three OFDM symbols of a subframe). DCI may be associated with a DCI format. The UE may blind decode multiple PDCCH candidates looking for DCI formats addressed to the UE.

Two-stage DCI is a two-step control signaling process used in an NR system. A stage 1 DCI may refer to a relatively short common DCI that is broadcast to multiple UEs. A stage 2 DCI may refer to a longer, UE-specific DCI that is sent in a dedicated search space. The stage 1 DCI may refer to the stage 2 DCI. The stage 1 DCI may be sent in a common control resource set (CORESET). The stage 1 DCI may indicate a pointer to a stage 2 DCI location, a type of transmission (e.g., uplink or downlink), a group identifier, and time and frequency information for the stage 2 DCI. The stage 2 DCI may be sent in a separate CORESET as compared to the stage 1 DCI. The stage 2 DCI may indicate a UE-specific resource allocation, an MCS, HARQ information, and other detailed parameters for data transfer.

A wakeup signal (WUS) is a low-complexity signal transmitted by the network node to wake up a UE that is in a discontinuous reception (DRX) or idle mode, such that the UE is then able to listen for an incoming control message, such as DCI. The UE may save power by not constantly listening to the PDCCH. After the UE receives the WUS, the UE may power on a main receiver in time to decode the incoming control message. The WUS may be transmitted shortly before a PDCCH monitoring occasion. When the UE detects the WUS, the UE may wake up and then listen to the PDCCH and possibly decode DCI to receive data or instructions. An NR low power WUS may enable a low power control signaling based PDCCH monitoring adaptation.

In the NR system, the CFI may be replaced with the usage of CORESETs. A CORESET is a time-frequency region in which the PDCCH is able to be transmitted. In the LTE system, the PDCCH is the first one, two, or three OFDM symbols of each subframe. In the LTE system, the PDCCH may be fixed and common to a plurality of UEs, where an indication of the PDCCH may be broadcast using the CFI on the PCFICH. In the NR system, the CORESETs are employed instead of the CFI. The CORESETs may be more flexible (e.g., more flexible in terms of time and frequency), configurable (e.g., per UE or per use case), and beam-aware. The CORESETs may be configured via radio resource control (RRC) signaling. However, by replacing the CFI with the CORESETs in the NR system, no immediate broadcast indicator may be present. The NR system may not have a broadcast CFI-equivalent, such that UEs may need to be preconfigured via RRC signaling with CORESET information. A pre-configuration via RRC signaling may not be dynamic per slot, may require signaling and memory for CORESET configurations, and may add setup complexity. As a result, eliminating the CFI altogether and replacing the CFI with the CORESETs in the NR system may degrade an overall system performance.

Various aspects relate generally to CFIs. Some aspects more specifically relate to transmitting CFI configurations associated with one or more CFI formats. In some examples, a UE may receive, from a network node, a CFI configuration that configures one or more CFI formats. The CFI configuration may enable a CFI feature based at least in part on a deployment scenario or a traffic condition. The CFI configuration may indicate a bitmap used for CFI decoding. The bitmap may be associated with the one or more CFI formats, where each bit of the bitmap may correspond to a specific CFI format. The CFI configuration may indicate CFI time domain location information. The UE may receive, from the network node and during an idle state, an inactive state, or a connected state of the UE, a CFI based at least in part on the CFI configuration. A wakeup of the UE from the idle state, the inactive state, or the connected state and a downlink channel monitoring at the UE may be based at least in part on a receipt of the CFI. The CFI may be associated with a group of CORESETs in accordance with the CFI configuration. The CFI may indicate a CORESET of the group of CORESETs that is to be monitored by the UE. The CFI may be associated with multiple subsets of a CORESET in accordance with the CFI configuration. The CFI may indicate a subset of the CORESET that is to be monitored by the UE. The CFI may indicate a CORESET and a subset associated with the CORESET that is to be monitored by the UE.

Particular aspects of the subject matter described in this disclosure can be implemented to realize one or more of the following potential advantages. In some examples, by transmitting the CFI configuration that configures the one or more CFI formats, the described techniques can be used by the UE to receive the CFI based at least in part on the CFI configuration. The CFI may not be an always-on CFI, but rather may be configured by the network node. For example, the CFI configuration may enable or disable a CFI feature depending on deployment scenarios or a traffic status. The CFI configuration may include a bitmap, where different bits of the bitmap may map to specific CFI formats. The UE may receive the CFI during the idle state, the inactive state, or the connected state of the UE, such that the CFI may serve to wake up the UE from the idle state, the inactive state, or the connected state and then perform the downlink channel monitoring. The CFI may serve to indicate a control region (e.g., CORESET or a subset associated with the CORESET) to be monitored and the CFI may serve to wake up the UE from the idle state, the inactive state, or the connected state. An ability for the CFI to be dynamically enabled by the network node, instead of being a static and always-on CFI, may provide additional flexibility to the network node and help with certain deployment scenarios or traffic conditions, thereby improving an overall system performance.

5G NR may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

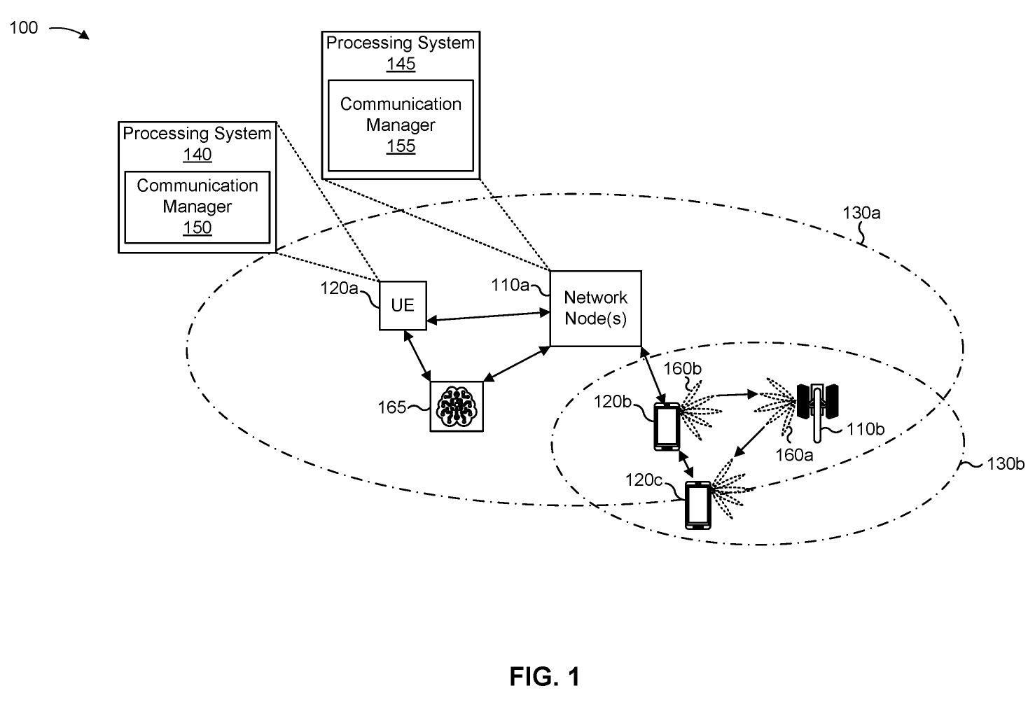

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers (CCs), or channels that define associated frequencies available for communications. In some examples, each of the network nodes 110 and the UEs 120 may communicate using one or multiple CCs in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, CCs, subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full CC bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including an MCS or RV parameters. Different DCI formats carry different information, such as scheduling information in the form of downlink or uplink grants, slot format indicators (SFIs), preemption indicators (PIs), transmit power control (TPC) commands, HARQ information, NDIs, among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-OFDM (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a UE (e.g., the UE 120) may include a communication manager 150. As described in more detail elsewhere herein, the communication manager 150 may receive a CFI configuration that configures one or more CFI formats; and receive a CFI based at least in part on the CFI configuration, wherein a wakeup of the UE and a downlink channel monitoring are based at least in part on a receipt of the CFI. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit a CFI configuration that configures one or more CFI formats; and transmit a CFI based at least in part on the CFI configuration, wherein a wakeup of a UE and a downlink channel monitoring are based at least in part on the CFI. Additionally, or alternatively, the communication manager 155 may perform one or more other operations described herein.

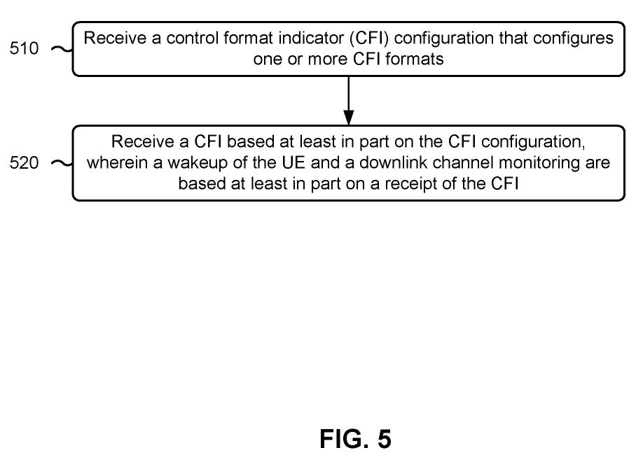

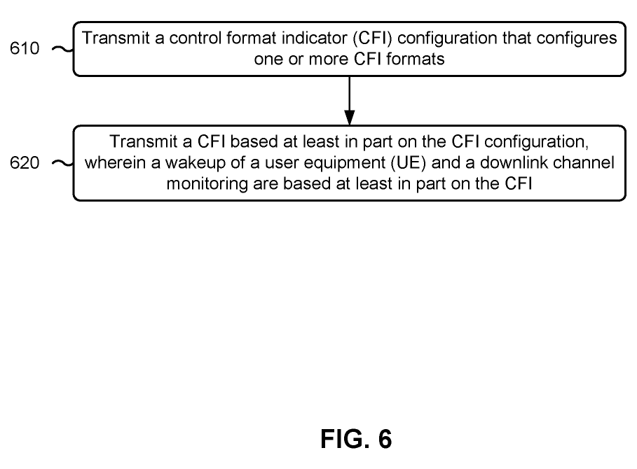

The network node 110, the processing system 145 of the network node 110, the UE 120, the processing system 140 of the UE 120, or any other component(s) of FIG. 1 may implement one or more techniques or perform one or more operations associated with transmitting CFI configurations associated with one or more CFI formats, as described in more detail elsewhere herein. For example, the processing system 145 of the network node 110, or the processing system 140 of the UE 120 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

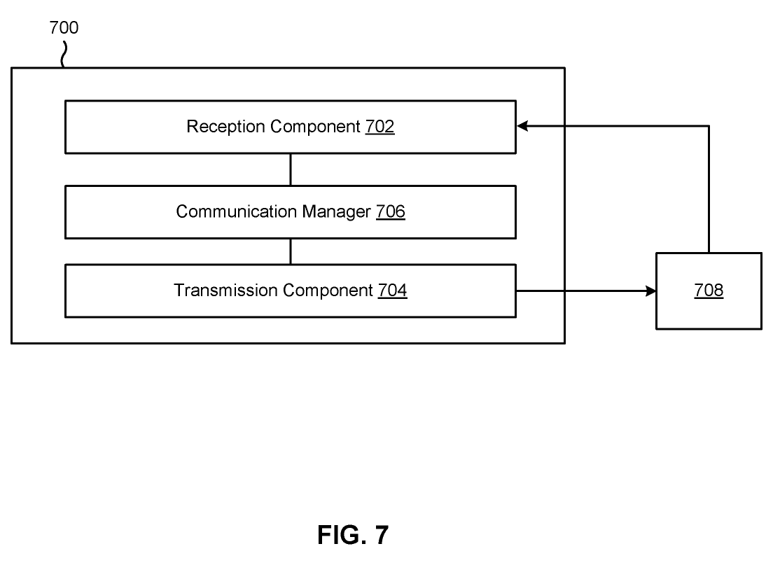

In some aspects, a UE (e.g., the UE 120) includes means for receiving a CFI configuration that configures one or more CFI formats; or means for receiving a CFI based at least in part on the CFI configuration, wherein a wakeup of the UE and a downlink channel monitoring are based at least in part on a receipt of the CFI. The means for the UE to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

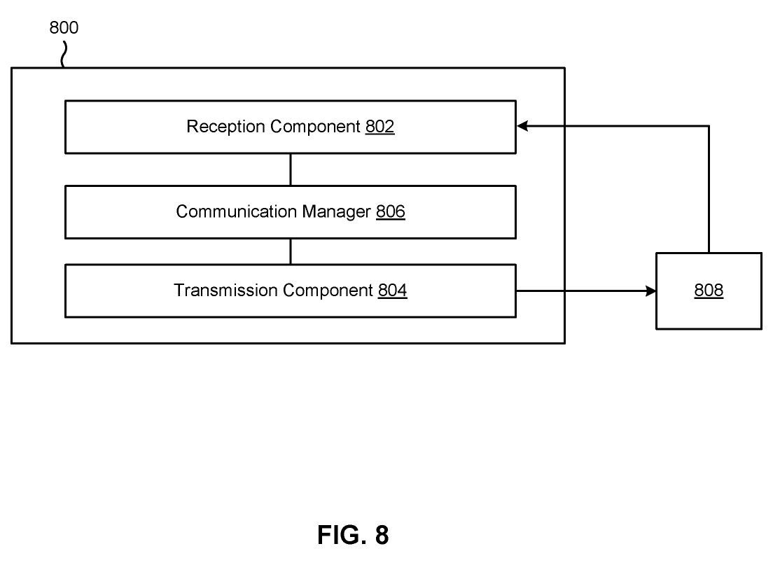

In some aspects, a network node (e.g., the network node 110) includes means for transmitting a CFI configuration that configures one or more CFI formats; or means for transmitting a CFI based at least in part on the CFI configuration, wherein a wakeup of a UE and a downlink channel monitoring are based at least in part on the CFI. The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

As indicated above, FIG. 1 is provided as an example. Other examples may differ from what is described with regard to FIG. 1.

In a wireless communication system, such as an LTE system, a CFI may enable a control resource adaptation in a time domain. The CFI may be an indicator that is transmitted by a network node to a UE. The CFI may indicate a number of OFDM symbols that are used for carrying a control channel, such as a PDCCH and a PHICH, at each subframe. When the CFI is set to “1” for a subframe, one OFDM symbol (e.g., the first OFDM symbol) of the subframe may be used for a PDCCH allocation. When the CFI is set to “2”, two OFDM symbols (e.g., the first OFDM symbol and the second OFDM symbol) of the subframe may be used for the PDCCH allocation.

The CFI may indicate the number of OFDM symbols in the subframe that are used for control information on the downlink. The CFI may indicate one OFDM symbol, two OFDM symbols, or three OFDM symbols. In other words, the CFI may indicate whether a control region spans the first one OFDM symbol, two OFDM symbols, or three OFDM symbols. The CFI may be transmitted on a PCFICH, which may appear in the first OFDM symbol of each subframe. The CFI may indicate to the UE the number of OFDM symbols to read in order to obtain the control information before decoding data. Remaining OFDM symbols in the subframe may be used for a PDSCH, which may be used to convey data.

The CFI may be associated with various limitations. The CFI may restrict a dynamic resource multiplexing across data channels and control resources. For example, in an NR system, a PCFICH based PDCCH time domain resource indication may be removed due to the restriction of the dynamic resource multiplexing across data channels and control resources. The CFI may gate or confine the PDCCH. A reliability of the CFI may be critical. When the CFI is decoded incorrectly, the PDCCH may not be properly decoded (e.g., PDCCH missing may be inevitable).

The CFI may indicate one, two, or three OFDM symbols per subframe, where such a fixed and narrow range may be insufficient in high traffic or high user density scenarios. A static nature of the CFI may result in wasted resources when an excessive number of OFDM symbols are allocated for the control information. Since the CFI is transmitted in the first OFDM symbol, any interference or corruption may cause the UE to misinterpret a control region size, miss PDCCH information altogether, or fail to decode scheduled data. The CFI may not be dynamic or flexible to dynamically changing traffic demands or new use cases. The CFI may not be suitable for beamforming or advanced antenna techniques. For example, the CFI may not support a flexible control region placement or beamformed control channels.

DCI may be transmitted over the PDCCH. DCI may indicate instructions that allows the UE to decode data received over the PDSCH or transmit data over a PUSCH. DCI may indicate a resource allocation, an MCS, HARQ process information, an NDI, an RV, power control commands, a TA command, an uplink grant, and/or a downlink assignment. The network node may transmit DCI on the PDCCH, which may be associated with the control region (e.g., a first three OFDM symbols of a subframe). DCI may be associated with a DCI format. The UE may blind decode multiple PDCCH candidates looking for DCI formats addressed to the UE.

Two-stage DCI is a two-step control signaling process used in an NR system. A stage 1 DCI may refer to a relatively short common DCI that is broadcast to multiple UEs. A stage 2 DCI may refer to a longer, UE-specific DCI that is sent in a dedicated search space. The stage 1 DCI may refer to the stage 2 DCI. The stage 1 DCI may be sent in a common CORESET. The stage 1 DCI may indicate a pointer to a stage 2 DCI location, a type of transmission (e.g., uplink or downlink), a group identifier (ID), and time and frequency information for the stage 2 DCI. The stage 2 DCI may be sent in a separate CORESET as compared to the stage 1 DCI. The stage 2 DCI may indicate a UE-specific resource allocation, an MCS, HARQ information, and other detailed parameters for data transfer.

A WUS is a low-complexity signal transmitted by the network node to wake up a UE that is in a DRX or idle mode, such that the UE is then able to listen for an incoming control message, such as DCI. The UE may save power by not constantly listening to the PDCCH. After the UE receives the WUS, the UE may power on a main receiver in time to decode the incoming control message. The WUS may be transmitted shortly before a PDCCH monitoring occasion. When the UE detects the WUS, the UE may wake up and then listen to the PDCCH and possibly decode DCI to receive data or instructions. An NR low power WUS may enable a low power control signaling based PDCCH monitoring adaptation.

In the NR system, the CFI may be replaced with the usage of CORESETs. A CORESET is a time-frequency region in which the PDCCH is able to be transmitted. In the LTE system, the PDCCH is the first one, two, or three OFDM symbols of each subframe. In the LTE system, the PDCCH may be fixed and common to a plurality of UEs, where an indication of the PDCCH may be broadcast using the CFI on the PCFICH. In the NR system, the CORESETs are employed instead of the CFI. The CORESETs may be more flexible (e.g., more flexible in terms of time and frequency), configurable (e.g., per UE or per use case), and beam-aware. The CORESETs may be configured via RRC signaling. However, by replacing the CFI with the CORESETs in the NR system, no immediate broadcast indicator may be present. The NR system may not have a broadcast CFI-equivalent, such that UEs may need to be preconfigured via RRC signaling with CORESET information. A pre-configuration via RRC signaling may not be dynamic per slot, may require signaling and memory for CORESET configurations, and may add setup complexity. As a result, eliminating the CFI altogether and replacing the CFI with the CORESETs in the NR system may degrade an overall system performance.

In various aspects of techniques and apparatuses described herein, a UE may receive, from a network node, a CFI configuration that configures one or more CFI formats. The CFI configuration may enable a CFI feature based at least in part on a deployment scenario or a traffic condition. The CFI configuration may indicate a bitmap used for CFI decoding. The bitmap may be associated with the one or more CFI formats, where each bit of the bitmap may correspond to a specific CFI format. The CFI configuration may indicate CFI time domain location information. The UE may receive, from the network node and during an idle state, an inactive state, or a connected state of the UE, a CFI based at least in part on the CFI configuration. A wakeup of the UE from the idle state, the inactive state, or the connected state and a downlink channel monitoring at the UE may be based at least in part on a receipt of the CFI. The CFI may be associated with a group of CORESETs in accordance with the CFI configuration. The CFI may indicate a CORESET of the group of CORESETs that is to be monitored by the UE. The CFI may be associated with multiple subsets of a CORESET in accordance with the CFI configuration. The CFI may indicate a subset of the CORESET that is to be monitored by the UE. The CFI may indicate a CORESET and a subset associated with the CORESET that is to be monitored by the UE.

In some aspects, the CFI may combine a functionality of a legacy CFI (e.g., an always-on CFI) and a WUS, where the CFI may be associated with a stage 1 DCI of a two-stage DCI. The CFI may enable a dynamic adaptation of a control region in both a frequency domain and a time domain. The CFI may not only indicate a resource adaptation in a CORESET, but may also function as the WUS. The UE may decode the stage 1 DCI, and when the stage 1 DCI includes the CFI, the UE may be instructed to wake up and monitor a control region. Depending on a CFI decoding, the UE may be indicated with a specific portion of the control region to monitor in order to decode a PDCCH signal. The CFI may be associated with a dual functionality of wakeup and resource adaptation

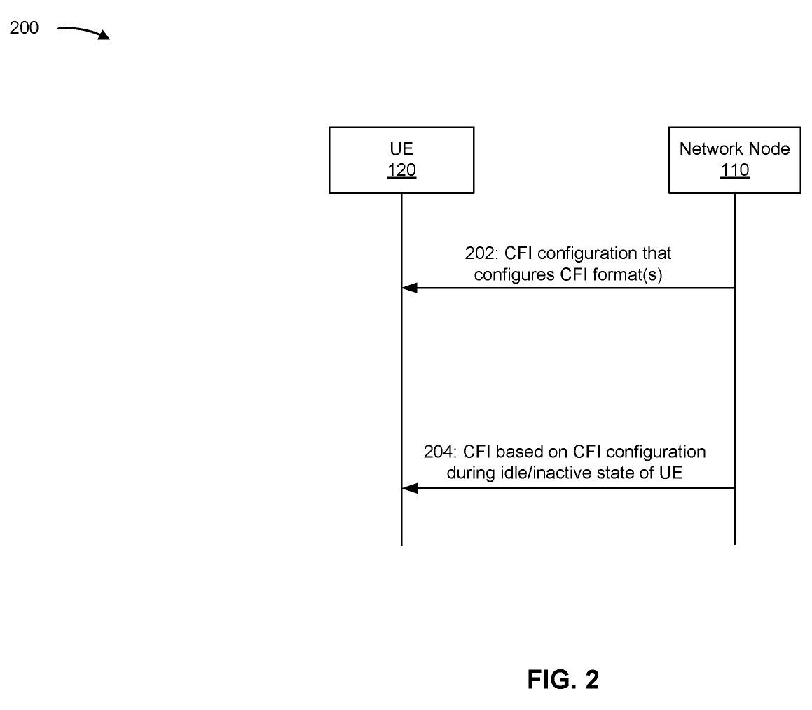

FIG. 2 is a diagram illustrating an example 200 associated with transmitting CFI configurations associated with one or more CFI formats. As shown in FIG. 2, example 200 includes communication between a UE 120 and a network node 110. In some aspects, the UE 120 and the network node 110 may be included in a wireless network, such as wireless network 100.

As shown by reference number 202, the UE 120 may receive, from the network node 110, a CFI configuration that configures one or more CFI formats. The CFI configuration may enable a CFI feature based at least in part on a deployment scenario or a traffic condition. Alternatively, the CFI configuration may disable the CFI feature based at least in part on the deployment scenario or the traffic condition. The CFI configuration may indicate a bitmap used for CFI decoding. The bitmap may be associated with the one or more CFI formats, where each bit of the bitmap may correspond to a specific CFI format. Different CFI formats may be associated with different network/traffic conditions. The one or more CFI formats may each be associated with a radio network temporary identifier (RNTI). The CFI configuration may indicate CFI time domain location information and/or CFI frequency domain location information, which may enable the UE 120 to monitor certain time-frequency domain resources in order to receive a CFI.

As shown by reference number 204, the UE 120 may receive, from the network node 110, the CFI based at least in part on the CFI configuration. The UE 120 may receive the CFI during an idle state, an inactive state, or a connected state of the UE 120. A wakeup of the UE 120 from the idle state, the inactive state, or the connected state and a downlink channel monitoring may be based at least in part on a receipt of the CFI. In other words, the UE 120 may receive the CFI, wakeup from the idle state, the inactive state, or the connected state based at least in part on the CFI, and then perform the downlink channel monitoring. In some aspects, the CFI may be associated with a group of CORESETs in accordance with the CFI configuration. A payload of the CFI may indicate a CORESET of the group of CORESETs that is to be monitored by the UE 120. In some aspects, the CFI may be associated with multiple subsets of a CORESET in accordance with the CFI configuration. A payload of the CFI may indicate a subset of the CORESET that is to be monitored by the UE 120. In some aspects, the CFI may indicate a CORESET and a subset associated with the CORESET that is to be monitored by the UE 120. In some aspects, the CFI may be associated with one or more cyclic redundancy check (CRC) bits.

In some aspects, the CFI configuration may include a first bitmap value. The first bitmap value may correspond to a first CFI format. The first CFI format may be indicated when the CFI is associated with the group of CORESETs, and when the CFI indicates the CORESET of the group of CORESETs that is to be monitored by the UE 120. In some aspects, the CFI configuration may include a second bitmap value. The second bitmap value may correspond to a second CFI format. The second CFI format may be indicated when the CFI is associated with the multiple subsets of the CORESET, and when the CFI indicates the subset of the CORESET that is to be monitored by the UE 120. In some aspects, the CFI configuration may include a third bitmap value. The third bitmap value may correspond to a third CFI format. The third CFI format may be indicated when the CFI indicates the CORESET and the subset associated with the CORESET that is to be monitored by the UE 120.

In some aspects, the CFI may be configured by the network node 110, instead of being an always-on CFI (e.g., as in an LTE system). The CFI may not be always on, but rather may be decided by a network configuration. The CFI may be associated with a two-stage control. The network node 110 may have flexibility to enable or disable the CFI based at least in part on a deployment scenario or a traffic status. The network node 110 may transmit, to the UE 120, the CFI configuration in order to configure the CFI. The CFI configuration may indicate a bitmap used for CFI decoding at the UE 120, where each bit of the bitmap may correspond to a specific CFI format. Multiple CFI bitmaps may be defined for the bitmap with the same length. The CFI formats may be associated with a specific RNTI. The CFI may be a UE-specific CFI or a group-specific CFI, where different RNTIs may be used for different types of CFI. CRC bits may be added to CFI payload bits to increase a CFI reliability. The UE 120 may read the CFI configuration, which may enable the CFI decoding at the UE 120.

In some aspects, the CFI configuration may include the bitmap to indicate different combinations of information to the UE 120. The different combinations of information may be associated with new functionalities that are introduced by the CFI. The bitmap may be able to indicate different CFI formats for different use cases. Different CFI formats may be associated with different functionality definitions. Different RNTIs may be used for the different use cases. The CRC bits may be used to increase a reliability of the CFI. In some aspects, the network node 110 may configure CFI time domain location information. The CFI time domain location information may include a monitoring occasion in a time domain (e.g., which symbol to monitor to receive the CFI), a symbol location, a slot location, a system frame number (SFN), and/or a periodicity of the monitoring occasion.

In some aspects, the CFI configuration may be associated with different options related to CORESETs. Different CORESETs may be associated with different time durations and/or different bandwidths. In a first option, the CFI configuration may define that the CFI is associated with a group of CORESETs, where the CFI (e.g., a CFI payload) may indicate to the UE 120 which CORESET is to be monitored by the UE 120. For example, a first CFI value may indicate no PDCCH (e.g., the UE 120 does not need to wake up to monitor a PDCCH), a second CFI value may indicate a first CORESET, a third CFI value may indicate a second CORESET, and a fourth CFI value may indicate a third CORESET. In a second option, the CFI configuration may define that the CFI is associated with multiple subsets of a CORESET, where the CFI may indicate to the UE 120 which subsets of the CORESET are to be monitored by the UE 120. For example, a first CFI value may indicate no PDCCH, a second CFI value may indicate a first subset of a CORESET, a third CFI value may indicate a second subset of the CORESET, and a fourth CFI value may indicate the first subset and the second subset of the CORESET. In a third option, the CFI configuration may define whether a PDCCH is to be monitored by the UE 120. When the PDCCH is to be monitored, the CFI configuration may further define which CORESET is to be monitored by the UE 120 and which subset (or multiple subsets) of that CORESET is to be monitored by the UE 120.

In some aspects, the CFI may be a beam-specific CFI. The CFI may be associated with an SSB beam or a CSI-RS beam. The CFI may have a one-to-one beam association relationship with the SSB beam or the CSI-RS beam. The CFI may be scrambled with a UE ID, a UE group ID, or a cell ID. The CFI may be scrambled with time domain information. The CFI may be frequency division multiplexed with other CFIs. The CFI may be spatial division multiplexed with the other CFIs. The CFI may be time division multiplexed with the other CFIs.

In some aspects, the CFI may be the beam specific CFI. The CFI may be beam specific in order to increase a reliability in higher frequency bands, such as FR1, FR2, or FR3. The CFI may be associated with a specific SSB beam or a specific CSI-RS beam. The CFI and an SSB/CSI-RS may have a one-to-one beam association relationship. The one-to-one beam association relationship may be associated with a QCL association. The CFI may be associated with a multi-beam sweep pattern. For example, a low power synchronization signal (LP-SS) occasion periodicity may include a plurality of repetitions, which may include a first repetition and a second repetition. The first repetition may include a CFI associated with beam 0 and a CFI associated with beam 1. The second repetition may include a CFI associated with beam 0 and a CFI associated with beam 1. The plurality of repetitions and the LP-SS occasion periodicity may be in accordance with the multi-beam sweep pattern. In this example, the CFI may be beam specific and support different beam sweeping patterns.

In some aspects, to reduce interference across CFIs, a CFI may be scrambled with the UE ID, the UE group ID, the cell ID, a combination of the cell ID and a beam index, or the time domain information. The time domain information may include a slot/symbol index. The CFI may be frequency division multiplexed, spatial domain multiplexed, or time domain multiplexed, in relation to other CFIs, in order to reduce interference across CFIs.

In some aspects, the CFI may be a cross-carrier CFI. The CFI may be associated with multiple CCs. The CFI may be associated with one or more active carriers in a virtual cell across a discontinuous spectrum. The virtual cell may include one or more downlink-uplink subbands, one or more CCs, or one or more cells. In some aspects, a timing offset between the CFI and an associated CORESET may be defined with a symbol or slot granularity of a CC with a largest SCS among a group of CCs. In some aspects, a timing offset between the CFI and an associated CORESET may be defined with a symbol or slot granularity of a CC with a higher SCS among a group of CCs.

In some aspects, the CFI may be the cross-carrier CFI. A single CFI may be used for a plurality of CCs, or the single CFI may be used for multiple CCs. A low band CFI with a higher reliability may be used to indicate a CORESET/PDCCH adaptation in high bands. In some aspects, the CFI may cover one or more active carriers (e.g., all carriers) in a virtual cell across a discontinuous spectrum. The virtual cell may include multiple downlink/uplink subbands, CCs, or cells. The virtual cell may be a grouping of different building blocks, such as the downlink/uplink subbands, CCs, or cells. Each of these building blocks may be part of the virtual cell or multiple virtual cells and/or may operate as an independent cell. The UE 120 may treat a combination of such building blocks as a single cell.

In some aspects, different CCs may have different SCSs. For example, a frequency division duplexing (FDD) CC SCS may be 15 kilohertz (KHz), while a time division duplexing (TDD) CC SCS may be 30 KHz. A timing relationship between the CFI and an associated CORESET may be reconsidered due to different CCs having different SCSs. In a first option, a timing offset between the CFI and the associated CORESET may be defined with a symbol/slot granularity of a CC with a largest SCS. For example, a CFI may be transmitted in a first CC with an SCS of 15 KHz, and a PDCCH may be applied for a second CC with an SCS of 30 KHz and a third CC with an SCS of 60 KHz. In this example, timing offsets between the CFI and the corresponding CORESET in the first CC, the second CC, and the third CC may be defined with a slot granularity of 0.25 milliseconds (ms). In a second option, a timing offset between the CFI and the associated CORESET may be defined with a symbol/slot granularity of a CC with a higher SCS. For example, a CFI may be transmitted in a first CC with an SCS of 15 KHz, and a PDCCH may be applied for a second CC with an SCS of 30 KHz and a third CC with an SCS of 60 KHz. In this example, timing offsets between the CFI and the corresponding CORESET in the first CC, the second CC, and the third CC may be defined with slot granularities of 1, 0.5, and 0.25 ms.

As indicated above, FIG. 2 is provided as an example. Other examples may differ from what is described with regard to FIG. 2.

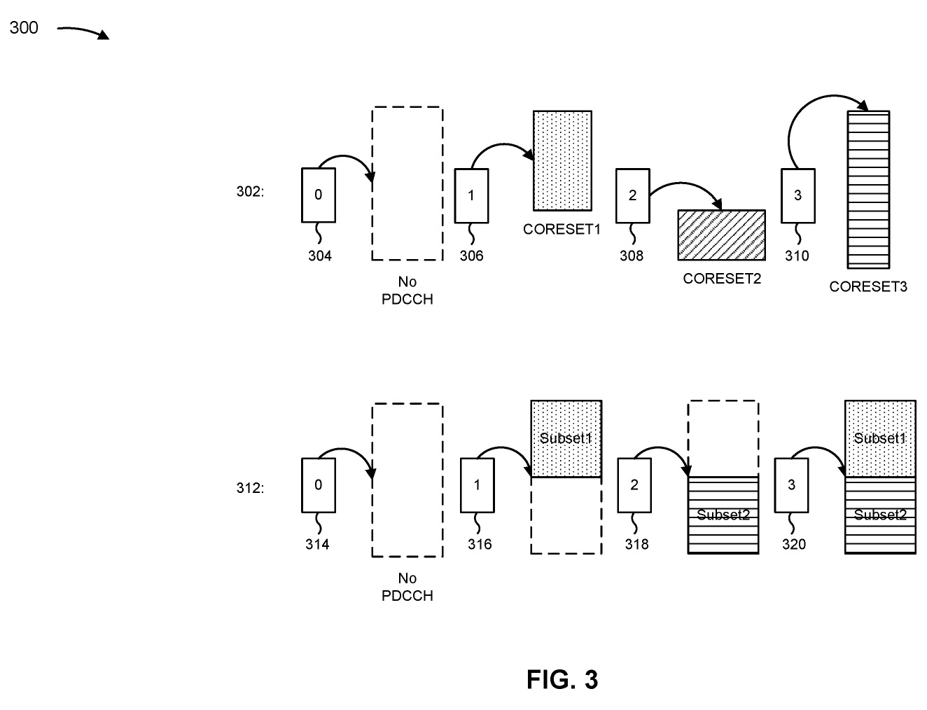

FIG. 3 is a diagram illustrating an example 300 associated with transmitting CFI configurations associated with one or more CFI formats.

As shown by reference number 302, a first CFI value 304 (e.g., 0) may indicate no PDCCH (e.g., a UE does not wake up to decode the PDCCH), a second CFI value 306 (e.g., 1) may indicate a first CORESET, a third CFI value 308 (e.g., 2) may indicate a second CORESET, and a fourth CFI value 310 (e.g., 3) may indicate a third CORESET. In this example, a CFI configuration may define that a CFI is associated with a group of CORESETs, where the CFI (e.g., a CFI payload) may indicate to the UE which CORESET is to be monitored by the UE. In this example, different CFI values may refer to different CFI decoding results.

As shown by reference number 312, a first CFI value 314 (e.g., 0) may indicate no PDCCH (e.g., a UE does not wake up to decode the PDCCH), a second CFI value 316 (e.g., 1) may indicate a first subset of a CORESET, a third CFI value 318 (e.g., 2) may indicate a second subset of the CORESET, and a fourth CFI value 320 (e.g., 3) may indicate the first subset and the second subset of the CORESET. In this example, a CFI configuration may define that a CFI is associated with multiple subsets of a CORESET, where the CFI may indicate to the UE which subsets of the CORESET are to be monitored by the UE. In this example, different CFI values may refer to different CFI decoding results.

As indicated above, FIG. 3 is provided as an example. Other examples may differ from what is described with regard to FIG. 3.

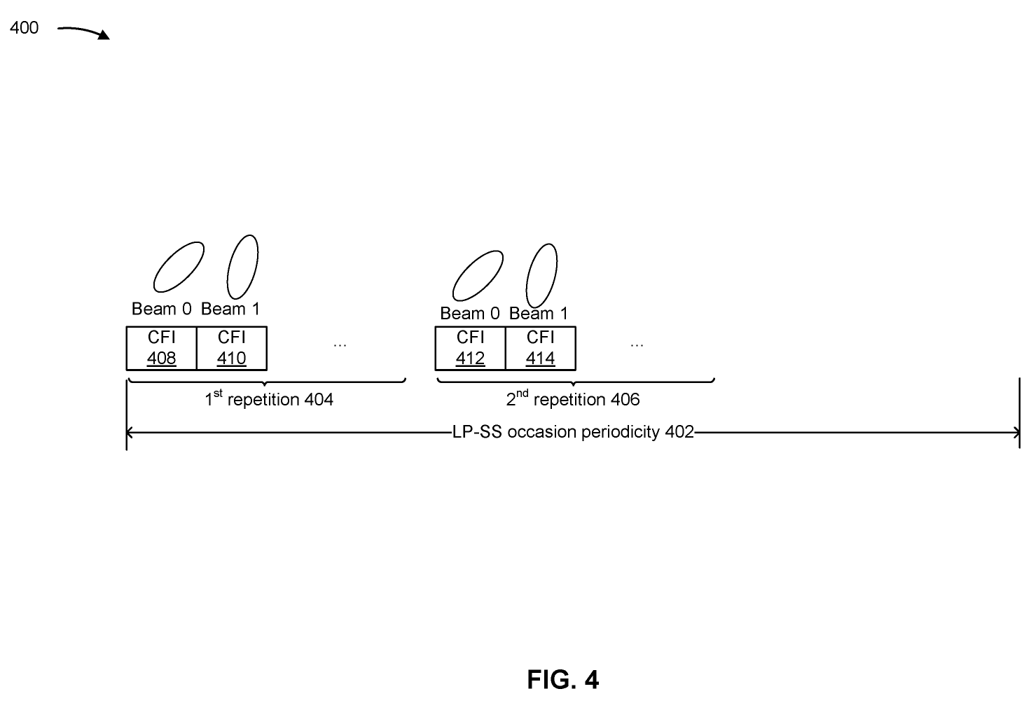

FIG. 4 is a diagram illustrating an example 400 associated with transmitting CFI configurations associated with one or more CFI formats.

As shown in FIG. 4, an LP-SS occasion periodicity 402 may include a plurality of repetitions, which may include a first repetition 404 and a second repetition 406. The first repetition 404 include a 408 CFI associated with beam 0 and a CFI 410 associated with beam 1. The second repetition 406 may include a CFI 412 associated with beam 0 and a CFI 414 associated with beam 1. The plurality of repetitions and the LP-SS occasion periodicity may be in accordance with a multi-beam sweep pattern. A network node may use the multi-beam sweep pattern to convey a CFI to a UE.

As indicated above, FIG. 4 is provided as an example. Other examples may differ from what is described with regard to FIG. 4.

FIG. 5 is a diagram illustrating an example process 500 performed, for example, at a UE or an apparatus of a UE. Example process 500 is an example where the apparatus or the UE (e.g., UE 120) performs operations associated with transmitting CFI configurations associated with one or more CFI formats.

As shown in FIG. 5, in some aspects, process 500 may include receiving a CFI configuration that configures one or more CFI formats (block 510). For example, the UE (e.g., using reception component 702 or communication manager 706, depicted in FIG. 7) may receive a CFI configuration that configures one or more CFI formats, as described above.

As further shown in FIG. 5, in some aspects, process 500 may include receiving a CFI based at least in part on the CFI configuration, wherein a wakeup of the UE and a downlink channel monitoring are based at least in part on a receipt of the CFI (block 520). For example, the UE (e.g., using reception component 702 or communication manager 706, depicted in FIG. 7) may receive a CFI based at least in part on the CFI configuration, wherein a wakeup of the UE and a downlink channel monitoring are based at least in part on a receipt of the CFI, as described above.

Process 500 may include additional aspects, such as any single aspect or any combination of aspects described below or in connection with one or more other processes described elsewhere herein.

In a first aspect, the CFI configuration enables or disables a CFI feature based at least in part on a deployment scenario or a traffic condition.

In a second aspect, alone or in combination with the first aspect, the CFI configuration indicates a bitmap used for CFI decoding, wherein the bitmap is associated with the one or more CFI formats, and each bit of the bitmap corresponds to a specific control information.

In a third aspect, alone or in combination with one or more of the first and second aspects, the one or more CFI formats are each associated with an RNTI.

In a fourth aspect, alone or in combination with one or more of the first through third aspects, the CFI is associated with one or more CRC bits.

In a fifth aspect, alone or in combination with one or more of the first through fourth aspects, the CFI configuration indicates CFI time domain location information.

In a sixth aspect, alone or in combination with one or more of the first through fifth aspects, the CFI is associated with a group of CORESETs in accordance with the CFI configuration, and a payload of the CFI indicates a CORESET of the group of CORESETs that is to be monitored by the UE.

In a seventh aspect, alone or in combination with one or more of the first through sixth aspects, the CFI is associated with multiple subsets of a CORESET in accordance with the CFI configuration, and a payload of the CFI indicates a subset of the CORESET that is to be monitored by the UE.

In an eighth aspect, alone or in combination with one or more of the first through seventh aspects, the CFI indicates a CORESET and a subset associated with the CORESET that is to be monitored by the UE.

In a ninth aspect, alone or in combination with one or more of the first through eighth aspects, the CFI is a beam-specific CFI.

In a tenth aspect, alone or in combination with one or more of the first through ninth aspects, the CFI is associated with an SSB beam or a CSI-RS beam, and the CFI has a one-to-one beam association relationship with the SSB beam or the CSI-RS beam.

In an eleventh aspect, alone or in combination with one or more of the first through tenth aspects, the CFI is scrambled with a UE ID, a UE group ID, or a cell ID, and the CFI is scrambled with time domain information.

In a twelfth aspect, alone or in combination with one or more of the first through eleventh aspects, the CFI is frequency division multiplexed with other CFIs, the CFI is spatial division multiplexed with the other CFIs, or the CFI is time division multiplexed with the other CFIs.

In a thirteenth aspect, alone or in combination with one or more of the first through twelfth aspects, the CFI is a cross-carrier CFI, and the CFI is associated with multiple CCs.

In a fourteenth aspect, alone or in combination with one or more of the first through thirteenth aspects, the CFI is associated with one or more active carriers in a virtual cell across a discontinuous spectrum, and the virtual cell includes one or more downlink-uplink subbands, one or more CCs, or one or more cells.

In a fifteenth aspect, alone or in combination with one or more of the first through fourteenth aspects, a timing offset between the CFI and an associated CORESET is defined with a symbol or slot granularity of a CC with a largest SCS among a group of CCs.

In a sixteenth aspect, alone or in combination with one or more of the first through fifteenth aspects, a timing offset between the CFI and an associated CORESET is defined with a symbol or slot granularity of a CC with a higher SCS among a group of CCs.

In a seventeenth aspect, alone or in combination with one or more of the first through sixteenth aspects, the CFI is received during an idle state, an inactive state, or a connected state of the UE, and the wakeup of the UE is from the idle state, the inactive state, or the connected state of the UE.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with transmitting CFI configurations associated with one or more CFI formats.

As shown in FIG. 6, in some aspects, process 600 may include transmitting a CFI configuration that configures one or more CFI formats (block 610). For example, the network node (e.g., using transmission component 804 or communication manager 806, depicted in FIG. 8) may transmit a CFI configuration that configures one or more CFI formats, as described above.

As further shown in FIG. 6, in some aspects, process 600 may include transmitting a CFI based at least in part on the CFI configuration, wherein a wakeup of a UE and a downlink channel monitoring are based at least in part on the CFI (block 620). For example, the network node (e.g., using transmission component 804 or communication manager 806, depicted in FIG. 8) may transmit a CFI based at least in part on the CFI configuration, wherein a wakeup of a UE and a downlink channel monitoring are based at least in part on the CFI, as described above.

Process 600 may include additional aspects, such as any single aspect or any combination of aspects described below or in connection with one or more other processes described elsewhere herein.

In a first aspect, the CFI configuration enables or disables a CFI feature based at least in part on a deployment scenario or a traffic condition.

In a second aspect, alone or in combination with the first aspect, the CFI configuration indicates a bitmap used for CFI decoding, wherein the bitmap is associated with the one or more CFI formats, and each bit of the bitmap corresponds to a specific control information.

In a third aspect, alone or in combination with one or more of the first and second aspects, the one or more CFI formats are each associated with an RNTI.

In a fourth aspect, alone or in combination with one or more of the first through third aspects, the CFI is associated with one or more CRC bits.

In a fifth aspect, alone or in combination with one or more of the first through fourth aspects, the CFI configuration indicates CFI time domain location information.

In a sixth aspect, alone or in combination with one or more of the first through fifth aspects, the CFI is associated with a group of CORESETs in accordance with the CFI configuration, and a payload of the CFI indicates a CORESET of the group of CORESETs that is to be monitored by the UE.

In a seventh aspect, alone or in combination with one or more of the first through sixth aspects, the CFI is associated with multiple subsets of a CORESET in accordance with the CFI configuration, and a payload of the CFI indicates a subset of the CORESET that is to be monitored by the UE.

In an eighth aspect, alone or in combination with one or more of the first through seventh aspects, the CFI indicates a CORESET and a subset associated with the CORESET that is to be monitored by the UE.

In a ninth aspect, alone or in combination with one or more of the first through eighth aspects, the CFI is a beam-specific CFI.

In a tenth aspect, alone or in combination with one or more of the first through ninth aspects, the CFI is associated with an SSB beam or a CSI-RS beam, and the CFI has a one-to-one beam association relationship with the SSB beam or the CSI-RS beam.

In an eleventh aspect, alone or in combination with one or more of the first through tenth aspects, the CFI is scrambled with a UE ID, a UE group ID, or a cell ID, and the CFI is scrambled with time domain information.

In a twelfth aspect, alone or in combination with one or more of the first through eleventh aspects, the CFI is frequency division multiplexed with other CFIs, the CFI is spatial division multiplexed with the other CFIs, or the CFI is time division multiplexed with the other CFIs.

In a thirteenth aspect, alone or in combination with one or more of the first through twelfth aspects, the CFI is a cross-carrier CFI, and the CFI is associated with multiple CCs.

In a fourteenth aspect, alone or in combination with one or more of the first through thirteenth aspects, the CFI is associated with one or more active carriers in a virtual cell across a discontinuous spectrum, and the virtual cell includes one or more downlink-uplink subbands, one or more CCs, or one or more cells.

In a fifteenth aspect, alone or in combination with one or more of the first through fourteenth aspects, a timing offset between the CFI and an associated CORESET is defined with a symbol or slot granularity of a CC with a largest SCS among a group of CCs.

In a sixteenth aspect, alone or in combination with one or more of the first through fifteenth aspects, a timing offset between the CFI and an associated CORESET is defined with a symbol or slot granularity of a CC with a higher SCS among a group of CCs.

In a seventeenth aspect, alone or in combination with one or more of the first through sixteenth aspects, the CFI is transmitted during an idle state, an inactive state, or a connected state of the UE, and the wakeup of the UE is from the idle state, the inactive state, or the connected state of the UE.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 2-4. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive a CFI configuration that configures one or more CFI formats. The reception component 702 may receive a CFI based at least in part on the CFI configuration, wherein a wakeup of the UE and a downlink channel monitoring are based at least in part on a receipt of the CFI.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 2-4. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit a CFI configuration that configures one or more CFI formats. The transmission component 804 may transmit a CFI based at least in part on the CFI configuration, wherein a wakeup of a UE and a downlink channel monitoring are based at least in part on the CFI.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving a control format indicator (CFI) configuration that configures one or more CFI formats; and receiving a CFI based at least in part on the CFI configuration, wherein a wakeup of the UE and a downlink channel monitoring are based at least in part on a receipt of the CFI.

Aspect 2: The method of Aspect 1, wherein the CFI configuration enables or disables a CFI feature based at least in part on a deployment scenario or a traffic condition.

Aspect 3: The method of any of Aspects 1-2, wherein the CFI configuration indicates a bitmap used for CFI decoding, wherein the bitmap is associated with the one or more CFI formats, and wherein each bit of the bitmap corresponds to a specific control information.

Aspect 4: The method of any of Aspects 1-3, wherein the one or more CFI formats are each associated with a radio network temporary identifier.

Aspect 5: The method of any of Aspects 1-4, wherein the CFI is associated with one or more cyclic redundancy check bits.

Aspect 6: The method of any of Aspects 1-5, wherein the CFI configuration indicates CFI time domain location information.

Aspect 7: The method of any of Aspects 1-6, wherein the CFI is associated with a group of control resource sets (CORESETs) in accordance with the CFI configuration, and wherein a payload of the CFI indicates a CORESET of the group of CORESETs that is to be monitored by the UE.

Aspect 8: The method of any of Aspects 1-7, wherein the CFI is associated with multiple subsets of a control resource set (CORESET) in accordance with the CFI configuration, and wherein a payload of the CFI indicates a subset of the CORESET that is to be monitored by the UE.

Aspect 9: The method of any of Aspects 1-8, wherein the CFI indicates a control resource set (CORESET) and a subset associated with the CORESET that is to be monitored by the UE.

Aspect 10: The method of any of Aspects 1-9, wherein the CFI is a beam-specific CFI.

Aspect 11: The method of any of Aspects 1-10, wherein the CFI is associated with a synchronization signal block (SSB) beam or a channel state information reference signal (CSI-RS) beam, and wherein the CFI has a one-to-one beam association relationship with the SSB beam or the CSI-RS beam.

Aspect 12: The method of any of Aspects 1-11, wherein the CFI is scrambled with a UE identifier (ID), a UE group ID, or a cell ID, and wherein the CFI is scrambled with time domain information.

Aspect 13: The method of any of Aspects 1-12, wherein the CFI is frequency division multiplexed with other CFIs, the CFI is spatial division multiplexed with the other CFIs, or the CFI is time division multiplexed with the other CFIs.

Aspect 14: The method of any of Aspects 1-13, wherein the CFI is a cross-carrier CFI, and wherein the CFI is associated with multiple component carriers.

Aspect 15: The method of any of Aspects 1-14, wherein the CFI is associated with one or more active carriers in a virtual cell across a discontinuous spectrum, and wherein the virtual cell includes one or more downlink-uplink subbands, one or more component carriers, or one or more cells.

Aspect 16: The method of any of Aspects 1-15, wherein a timing offset between the CFI and an associated control resource set is defined with a symbol or slot granularity of a component carrier (CC) with a largest subcarrier spacing among a group of CCs.

Aspect 17: The method of any of Aspects 1-16, wherein a timing offset between the CFI and an associated control resource set is defined with a symbol or slot granularity of a component carrier (CC) with a higher subcarrier spacing among a group of CCs.

Aspect 18: The method of any of Aspects 1-17, wherein the CFI is received during an idle state, an inactive state, or a connected state of the UE, and the wakeup of the UE is from the idle state, the inactive state, or the connected state of the UE.

Aspect 19: A method of wireless communication performed by a network node, comprising: transmitting a control format indicator (CFI) configuration that configures one or more CFI formats; and transmitting a CFI based at least in part on the CFI configuration, wherein a wakeup of a user equipment (UE) and a downlink channel monitoring are based at least in part on the CFI.

Aspect 20: The method of Aspect 19, wherein the CFI configuration enables or disables a CFI feature based at least in part on a deployment scenario or a traffic condition.

Aspect 21: The method of any of Aspects 19-20, wherein the CFI configuration indicates a bitmap used for CFI decoding, wherein the bitmap is associated with the one or more CFI formats, and wherein each bit of the bitmap corresponds to a specific control information.

Aspect 22: The method of any of Aspects 19-21, wherein the one or more CFI formats are each associated with a radio network temporary identifier.

Aspect 23: The method of any of Aspects 19-22, wherein the CFI is associated with one or more cyclic redundancy check bits.

Aspect 24: The method of any of Aspects 19-23, wherein the CFI configuration indicates CFI time domain location information.

Aspect 25: The method of any of Aspects 19-24, wherein the CFI is associated with a group of control resource sets (CORESETs) in accordance with the CFI configuration, and wherein a payload of the CFI indicates a CORESET of the group of CORESETs that is to be monitored by the UE.

Aspect 26: The method of any of Aspects 19-25, wherein the CFI is associated with multiple subsets of a control resource set (CORESET) in accordance with the CFI configuration, and wherein a payload of the CFI indicates a subset of the CORESET that is to be monitored by the UE.

Aspect 27: The method of any of Aspects 19-26, wherein the CFI indicates a control resource set (CORESET) and a subset associated with the CORESET that is to be monitored by the UE.

Aspect 28: The method of any of Aspects 19-27, wherein the CFI is a beam-specific CFI.

Aspect 29: The method of any of Aspects 19-28, wherein the CFI is associated with a synchronization signal block (SSB) beam or a channel state information reference signal (CSI-RS) beam, and wherein the CFI has a one-to-one beam association relationship with the SSB beam or the CSI-RS beam.

Aspect 30: The method of any of Aspects 19-29, wherein the CFI is scrambled with a UE identifier (ID), a UE group ID, or a cell ID, and wherein the CFI is scrambled with time domain information.

Aspect 31: The method of any of Aspects 19-30, wherein the CFI is frequency division multiplexed with other CFIs, the CFI is spatial division multiplexed with the other CFIs, or the CFI is time division multiplexed with the other CFIs.

Aspect 32: The method of any of Aspects 19-31, wherein the CFI is a cross-carrier CFI, and wherein the CFI is associated with multiple component carriers.

Aspect 33: The method of any of Aspects 19-32, wherein the CFI is associated with one or more active carriers in a virtual cell across a discontinuous spectrum, and wherein the virtual cell includes one or more downlink-uplink subbands, one or more component carriers, or one or more cells.

Aspect 34: The method of any of Aspects 19-33, wherein a timing offset between the CFI and an associated control resource set is defined with a symbol or slot granularity of a component carrier (CC) with a largest subcarrier spacing among a group of CCs.

Aspect 35: The method of any of Aspects 19-34, wherein a timing offset between the CFI and an associated control resource set is defined with a symbol or slot granularity of a component carrier (CC) with a higher subcarrier spacing among a group of CCs.

Aspect 36: The method of any of Aspects 19-35, wherein the CFI is received during an idle state, an inactive state, or a connected state of the UE, and the wakeup of the UE is from the idle state, the inactive state, or the connected state of the UE.

Aspect 37: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-36.

Aspect 38: An apparatus for wireless communication at a device, the apparatus comprising one or more memories and one or more processors coupled to the one or more memories, the one or more processors configured to cause the device to perform the method of one or more of Aspects 1-36.

Aspect 39: An apparatus for wireless communication, the apparatus comprising at least one means for performing the method of one or more of Aspects 1-36.

Aspect 40: A non-transitory computer-readable medium storing code for wireless communication, the code comprising instructions executable by one or more processors to perform the method of one or more of Aspects 1-36.

Aspect 41: A non-transitory computer-readable medium storing a set of instructions for wireless communication, the set of instructions comprising one or more instructions that, when executed by one or more processors of a device, cause the device to perform the method of one or more of Aspects 1-36.

Aspect 42: A device for wireless communication, the device comprising a processing system that includes one or more processors and one or more memories coupled with the one or more processors, the processing system configured to cause the device to perform the method of one or more of Aspects 1-36.

Aspect 43: An apparatus for wireless communication at a device, the apparatus comprising one or more memories and one or more processors coupled to the one or more memories, the one or more processors individually or collectively configured to cause the device to perform the method of one or more of Aspects 1-36.

Aspect 44: A device comprising a processing system that includes one or more processors and one or more code-storing memories coupled with the one or more processors, the processing system configured to cause the device to perform the method of one or more of Aspects 1-36.

Aspect 45: A device comprising a processing system that includes processor circuitry and code-storing memory circuitry, the processing system configured to cause the device to perform the method of one or more of Aspects 1-36.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, which are configured, individually or in any combination, to:
receive a control format indicator (CFI) configuration that configures one or more CFI formats; and
receive a CFI based at least in part on the CFI configuration, wherein a wakeup of the UE and a downlink channel monitoring are based at least in part on a receipt of the CFI.

2. The apparatus of claim 1, wherein the CFI configuration enables or disables a CFI feature based at least in part on a deployment scenario or a traffic condition.

3. The apparatus of claim 1, wherein the CFI configuration indicates a bitmap used for CFI decoding, wherein the bitmap is associated with the one or more CFI formats, and wherein each bit of the bitmap corresponds to a specific control information.

4. The apparatus of claim 1, wherein the one or more CFI formats are each associated with a radio network temporary identifier.

5. The apparatus of claim 1, wherein the CFI is associated with one or more cyclic redundancy check bits.

6. The apparatus of claim 1, wherein the CFI configuration indicates CFI time domain location information.

7. The apparatus of claim 1, wherein the CFI is associated with a group of control resource sets (CORESETs) in accordance with the CFI configuration, and wherein a payload of the CFI indicates a CORESET of the group of CORESETs that is to be monitored by the UE.

8. The apparatus of claim 1, wherein the CFI is associated with multiple subsets of a control resource set (CORESET) in accordance with the CFI configuration, and wherein a payload of the CFI indicates a subset of the CORESET that is to be monitored by the UE.

9. The apparatus of claim 1, wherein the CFI indicates a control resource set (CORESET) and a subset associated with the CORESET that is to be monitored by the UE.

10. The apparatus of claim 1, wherein the CFI is a beam-specific CFI.

11. The apparatus of claim 1, wherein the CFI is associated with a synchronization signal block (SSB) beam or a channel state information reference signal (CSI-RS) beam, and wherein the CFI has a one-to-one beam association relationship with the SSB beam or the CSI-RS beam.

12. The apparatus of claim 1, wherein the CFI is scrambled with a UE identifier (ID), a UE group ID, or a cell ID, and wherein the CFI is scrambled with time domain information.

13. The apparatus of claim 1, wherein the CFI is frequency division multiplexed with other CFIs, the CFI is spatial division multiplexed with the other CFIs, or the CFI is time division multiplexed with the other CFIs.

14. The apparatus of claim 1, wherein the CFI is a cross-carrier CFI, and wherein the CFI is associated with multiple component carriers.

15. The apparatus of claim 1, wherein the CFI is associated with one or more active carriers in a virtual cell across a discontinuous spectrum, and wherein the virtual cell includes one or more downlink-uplink subbands, one or more component carriers, or one or more cells.

16. The apparatus of claim 1, wherein a timing offset between the CFI and an associated control resource set is defined with a symbol or slot granularity of a component carrier (CC) with a largest subcarrier spacing among a group of CCs.

17. The apparatus of claim 1, wherein a timing offset between the CFI and an associated control resource set is defined with a symbol or slot granularity of a component carrier (CC) with a higher subcarrier spacing among a group of CCs.

18. The apparatus of claim 1, wherein the CFI is received during an idle state, an inactive state, or a connected state of the UE, and wherein the wakeup of the UE is from the idle state, the inactive state, or the connected state of the UE.

19. An apparatus for wireless communication at a network node, comprising:
one or more memories; and
one or more processors, coupled to the one or more memories, which are configured, individually or in any combination, to:
transmit a control format indicator (CFI) configuration that configures one or more CFI formats; and
transmit a CFI based at least in part on the CFI configuration, wherein a wakeup of a user equipment (UE) and a downlink channel monitoring are based at least in part on the CFI.

20. A method of wireless communication performed by a user equipment (UE), comprising:
receiving a control format indicator (CFI) configuration that configures one or more CFI formats; and
receiving a CFI based at least in part on the CFI configuration, wherein a wakeup of the UE and a downlink channel monitoring are based at least in part on a receipt of the CFI.
